(19) United States
(12) Patent Application Publication
(10) Pub. No.: US 2004/0155925 A1
(43) Pub. Date: Aug. 12, 2004

(54) Printing apparatus

(76) Inventors: Wendy L. Zerza, Boise, ID (US); Vincent C. Skurdal, Boise, ID (US); Boyd Wilkes, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/360,009

(22) Filed: Feb. 6, 2003

(51) Int. Cl. B41J 2/14; B41J 2/16

(52) U.S. Cl. 347/49

(57) ABSTRACT

A printing apparatus including a first cartridge having at least one reservoir for holding a first color of ink, a multi-color cartridge including three reservoirs capable of holding a second color of ink, a third color of ink and a fourth color of ink, and a third cartridge having at least one reservoir for holding ink. The printing apparatus can have a holder for holding the first cartridge, the second multi-color cartridge and the third cartridge.

### TECHNICAL FIELD

Embodiments of the invention relate generally to color cartridges for use in color printers. Specifically, the invention relates to various embodiments of a printing apparatus and method for multi-color cartridges.

### BACKGROUND INFORMATION

Inkjet printing mechanisms use cartridges, often called “pens,” which eject drops of liquid colorant, referred to generally herein as “ink,” onto a page. Each pen has a printhead formed with very small nozzles through which the ink drops are fired. To print an image, the printhead is propelled back and forth across the page, ejecting drops of ink in a desired pattern as it moves. The particular ink ejection mechanism within the printhead can include a piezo-electric or a thermal printhead mechanism.

Typically, the inks used in an inkjet printer are supplied in a reservoir of an inkjet cartridge. Some cartridges are monochrome and carry a single color such as black ink. Other cartridges are multi-color, and typically include reservoirs that carry the three ink colors of cyan, magenta and yellow needed for mixing, with black ink, to form most other colors. The multi-color cartridges typically are said to include three color “pens” while the monochrome color cartridges include one “pen”. There are also printing mechanisms that use four monochrome cartridges. In systems that use multi-color cartridges, when one of the “pens” or color reservoir is emptied, the entire cartridge is replaced. The result is that any remaining color or colors associated with the other pens are wasted. In some applications, the color mixtures used for color printing may have a tendency to consistently use up one of the colors of the multi-color cartridges more frequently. For example, if the nature of printing at a company always involves the heavy use of yellow ink, the end result is that the company will waste many multi-color cartridges having partially filled reservoirs with cyan and magenta inks. In other words, a company or household will needlessly waste resources. The multi-color cartridges provide both the purchaser and the store with a single consumable item which is easily ordered, stocked, and replaced. The disadvantage of the multi-color cartridges is that some ink may be wasted because one color typically runs out before the others, resulting in a higher cost per page of printing for the consumer.

Another problem occurs when many printing applications consistently need a special or custom color. For example, companies may tightly control a trademark and even require a very specific color only be used each time the trademark is written. This may occur in operations that print or reproduce company brochures or that print letterhead for use throughout a company. Again, such applications may consistently require one of the three colors more often than the other colors, as discussed above. Also, it is generally less efficient to print a color by mixing the color from other colors than to atomize and print the color directly. Furthermore, the color quality from mixed inks may be less consistent.

### BRIEF DESCRIPTION OF THE DRAWINGS

FIG. 1 is a perspective view of a printing apparatus according to one embodiment of the invention.

FIG. 2 is a perspective view of a printing apparatus according to another embodiment of the invention.

FIG. 3 is a perspective view of a carriage for holding print cartridge having three slots adapted to hold cartridges according to an embodiment of the invention.

FIG. 4 is a schematic view of a carriage according to another embodiment of the invention (off axis reservoir).

FIG. 5 is a schematic view of a controller according to an embodiment of the invention.

FIG. 6 is a flow diagram illustrating a method according to an embodiment of the invention.

FIG. 7 is a flow diagram illustrating a method according to another embodiment of the invention.

FIG. 8 is a schematic diagram illustrating a computer readable medium and associated instruction set according to an embodiment of the invention.

### DETAILED DESCRIPTION OF THE INVENTION

In the following detailed description of the preferred embodiments, reference is made to the accompanying drawings that form a part hereof, and in which are shown by way of illustrating specific embodiments in which the invention can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of present inventions. The following detailed description, therefore, is not to be taken in a limiting sense, and the scope of various embodiments of the invention is defined only by the appended claims, along with the full range of equivalents to which such claims are entitled.

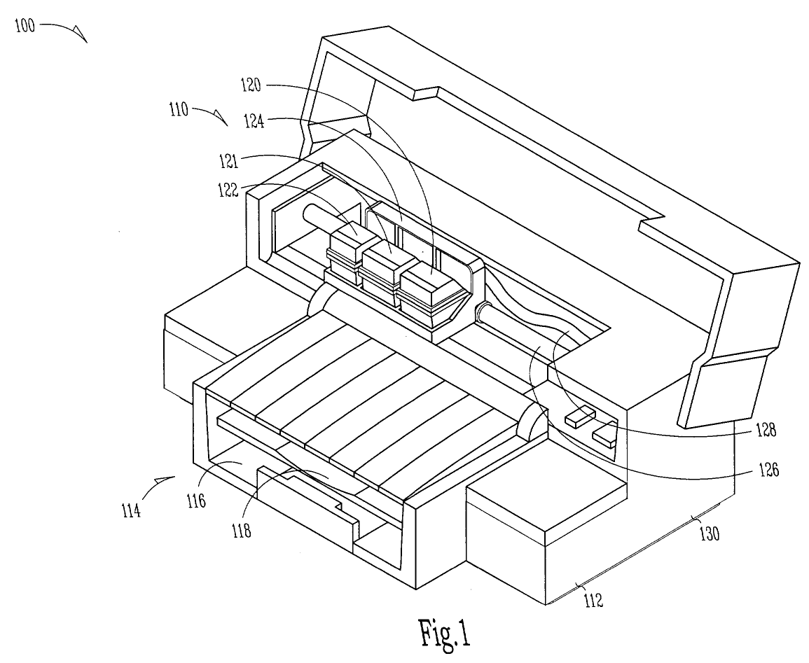

FIG. 1 shows one embodiment of a printing apparatus 100. FIG. 1 includes an inkjet printer 110, which can be used in an office or home environment for business reports, correspondence, desktop publishing, and the like. The inkjet printer 110 includes a chassis 112 and a print medium handling system 114 for supplying a print medium, such as a sheet of paper (not shown), to the printer 110. In addition to paper, the print medium can be any type of suitable sheet material, such as card-stock, transparencies, mylar, foils, and similar print medium. The print medium handling system 114 includes a feed tray 116, an output tray 118, and a series of rollers (not shown) for delivering the sheets of paper from the feed tray 116 into position for receiving ink from a plurality of inkjet cartridges 120, 121, 122. Inkjet cartridge 120 is a multi-color cartridge, such as a tri-color ink cartridge. Inkjet cartridge 121 is a black monochrome ink cartridge. Inkjet cartridge 122 is another monochrome ink cartridge carrying ink of a selected color. It should be noted that term “ink”, as used in this document, may be used to refer to any substance that can be used to mark a print medium. The term “ink” may refer to liquid ink, dry toner, liquid toner, etc. It should also be noted that the term “pen” is sometimes used in place of the term “cartridge”.

The ink cartridges or pens 120, 121, 122 are transported by a carriage 124 which can be driven along a guide rod 126 by a drive belt/pulley and motor arrangement (not shown). The pens 120, 121, 122 selectively deposit one or more ink droplets on a sheet of paper or other medium in accordance with instructions received via a conductor strip 128 from a printer controller 130 located within chassis 112, for instance at the location shown in FIG. 1. The controller 130 generally receives instructions from a computer (not shown), such as a personal computer. A monitor (not shown) coupled to the computer can be used to display visual information to an operator, such as the printer status or a particular program being run on the computer.

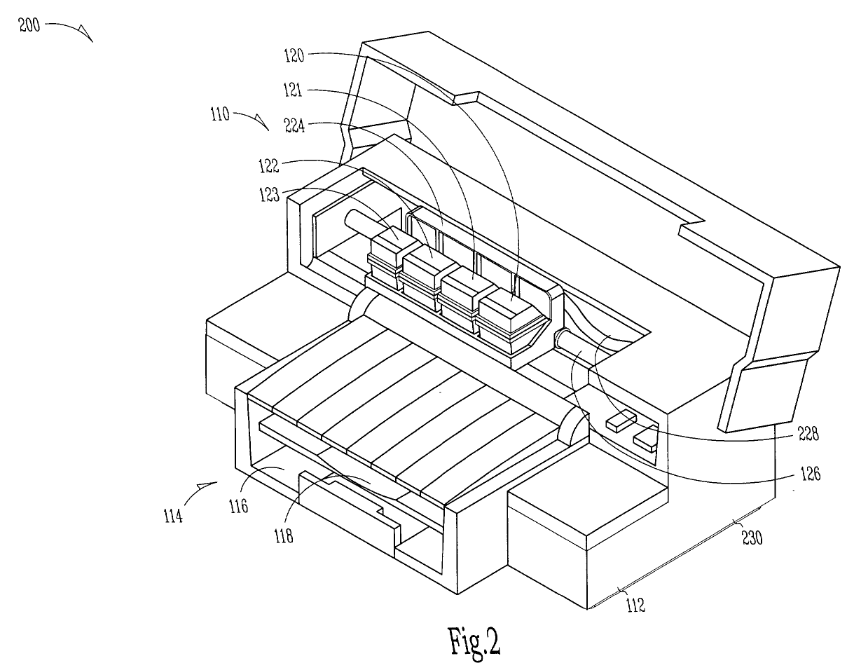

FIG. 2 is a perspective view of a printing apparatus 200 according to another embodiment. The printing apparatus 200 includes many of the same parts as the printing apparatus 100. For the sake of clarity, as well as the sake of brevity, only the differences between the printing apparatus 100 and the printing apparatus 200 will be described. The printing apparatus 200 includes four cartridges 120, 121, 122, and 123. The printing apparatus 100, by contrast, only includes three printing cartridges. It should be noted that printing apparatus 100 and printing apparatus 200 are only two embodiments of the invention. It should be noted that a printing apparatus having any number of printing cartridges beyond two printing cartridges is contemplated as various embodiments of this invention. The idea behind the various embodiments of the invention is that one or more spare cartridges, such as 122, 123, are provided to either hold one or more of the colors held within reservoirs of the first two cartridges 120, 121, or the additional or spare cartridges 122, 123 can be used to hold one or more custom colors. It is also contemplated that there could be a combination of a custom color and one or more of the colors found in the first two cartridges 120, 121. The additional cartridge or cartridges could also be a tri-color cartridge that could carry three substitute colors, or three custom colors, or a combination of either custom or substitute colors. The carriage or holder 224 is also different in that it includes openings or slots for receiving four cartridges 120, 121, 122, 123. The conductor strip 228 such as a flex cable which carries instructions to the various pens or cartridges 120, 122, 123 has additional conductors for controlling the additional cartridge 123. In addition, the controller 230 also includes an expanded instruction set which includes instructions for controlling the additional cartridge 123 found in the printing apparatus 200.

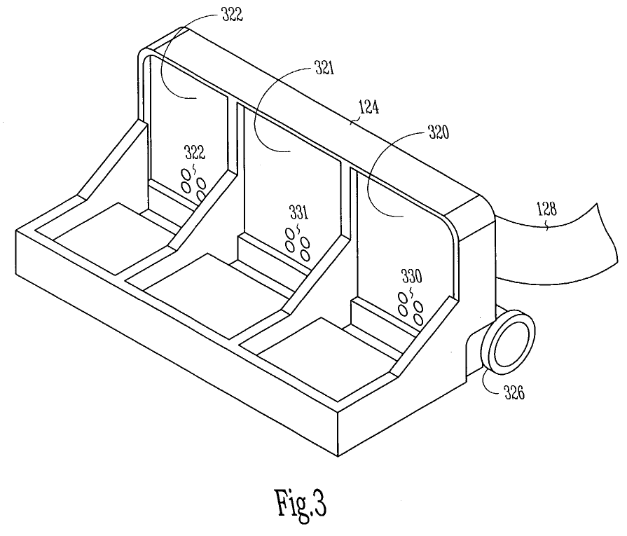

FIG. 3 is a perspective view of a carriage or holder 124 for holding the print cartridges 121, 122, 120 (shown in FIG. 1). The carriage 124 includes three openings or slots 320, 321, 322 which are adapted to receive the ink jet cartridges 120, 121, 122. In other words, the openings or slots 320, 321, 322 have a similar geometric shape to allow the cartridges 120, 121, 122 to fit within the slots. Each slot or opening 320, 321, 322 also has a set of electrical contacts 330, 331, and 332 positioned within the slot 320, 321, 322. The electrical contacts 330, 331, 332 correspond to electrical contacts associated with the ink jet cartridges 120, 121, 122. The electrical contacts with 330, 331, 332 are also in electrical communication with a set of corresponding conductors in a conductor strip 128, such as a flex cable. A flex cable includes flexible electrical conductive paths within a strip of polyamid. The conductor strip 128 which is a flex cable can then move along and flex as the carriage or holder 124 moves along the guide rod 126 (shown in FIG. 1). The carriage or holder 124 also includes a sleeve 326 which fits over or fits upon the guide rod 126.

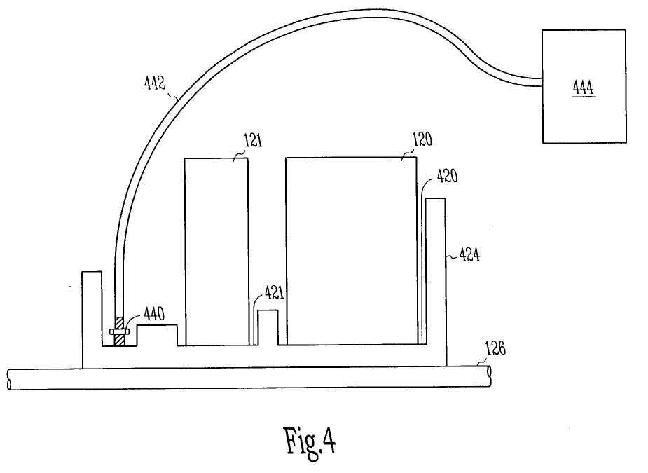

FIG. 4 is a schematic view of a carriage 424, according to another embodiment of this invention. The holder 424 includes openings or slots 420, 421 adapted to receive cartridges 120, 121. In addition, the holder or carriage 424 includes a fitting 440 for receiving ink via a flexible tube 442. The flexible tube 442 is attached to an ink supply 444 that is remote from the carriage 424. The carriage 424 is positionable along the guide rod 126. The ink supply 444 is pressurized and supplies ink to the carriage 424 under control of the controller such as 130, 230. The ink supply 444 is said to be off-axis. The ink supply could be either a substitute color or a custom color. A substitute color would correspond to one of the colors found within the cartridges 120 and 121. The colors found within these cartridges would by cyan, magenta, yellow, and black. It should be noted that other colors might be found in these two cartridges 120, 121. The two cartridges 120, 121 could be two multi-color cartridges, or one monochrome cartridge and one tri-color cartridges. A custom color can be used for particular printing jobs that require large amounts of one color, such as letterhead for company logo, or the like.

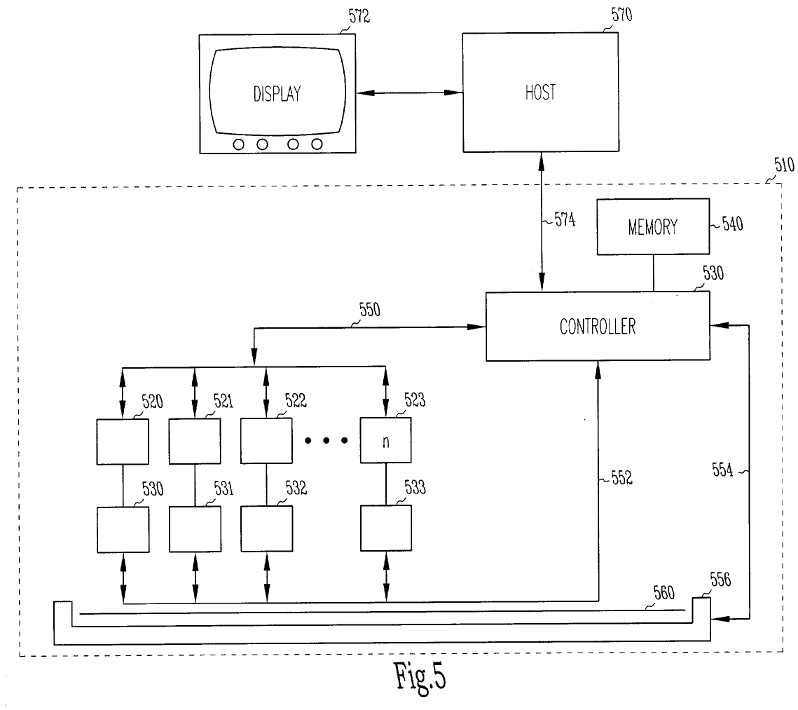

FIG. 5 is a schematic view of controller according to an embodiment of this invention. The controller 530 controls many aspects of the printer. The controller 530 controls the transfer of information between ink reservoirs 520, 521, 522, and 523, as well as the control of information to and from the printheads 530, 531, 532, 533. Much of the information is obtained from memory or a storage device 540. The memory 540 includes an indication of the colors in the various reservoirs 520, 521, 522, and 523. The memory 540 also contains information as to the levels of ink within the various reservoirs 520, 521, 522, 523. Electrical contacts associated with each of the reservoirs 520, 521, 522, 523 receives signals over conductive paths represented by the line 550. The controller 530 selectively activates each printhead 530, 531, 532, 533 to eject or deposit ink from the respective reservoirs onto print media 560. The printheads 530, 531, 532, 533 are controlled by line 552. A line 554 is attached to a printer mechanism 556 for controlling media transport and movement of a carriage, such as carriage 124, 224.

The controller 530 is also communicatively coupled to a host computer 570. The host computer 570 is shown connected to a display device 572. The host computer 570 can be a variety of information sources such as a personal computer, work station, or server, to name a few, that provide image information to the controller 530 by way of a data link 574. The data link 574 can be any one of a variety of data links such as an electrical link, a radio frequency (“RF”) link, an infrared link, or an optical link. The optical link can include optical fiber. The data link transfers information between the host computer 570 and the printing apparatus 510. The printing apparatus 510 is the portion of the schematic which is associated with the printer.

Various parameters can be stored in the storage device or memory 540, including the actual count of ink drops emitted from a particular printhead 530, 531, 532, 533, data associated with an ink reservoir or container 520, 521, 522, 523, as well as the ink type and color, the container size, the age of the ink, the printer model or identification number, and cartridge usage information, which is just a partial example of a listing of parameters storable within the memory 540. The controller 530 is an information handling system and can be either a microprocessor or a dedicated controller. The controller 530 is capable of detecting the colors within the reservoirs 520, 521, 522, 523, by detecting a color from indicia associated with the reservoirs 520, 521, 522, 523. Indicia can be any type of readable indicator including bar codes, switch bumps, magnetically readable media, radio frequency label or a memory chip. In one embodiment, data associated with ink within a cartridge or reservoir 520, 521, 522, 523 is obtained through electrical contacts associated with the cartridge or reservoir 520, 521, 522, 523. The host computer 570 can also provide information to the controller 530 regarding particular colors to be printed. For example, the host computer 570 can include custom color requirements or commands in a print command sent from the host 570 over the data link 574.

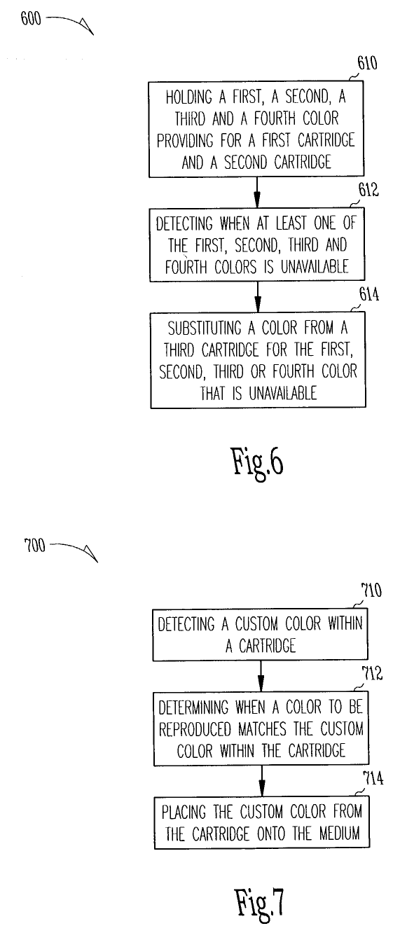

FIG. 6 is a flow diagram illustrating a method 600 according to an embodiment of the invention. The method includes a first cartridge and a second cartridge that hold a first, a second, a third, and a fourth color, as depicted by reference numeral 610. When at least one of the first, the second, the third, or the fourth colors is unavailable, it is detected as depicted by reference numeral 612. A color from a third cartridge is substituted for the first, the second, the third, or the fourth color that is unavailable, as depicted by reference numeral 614. The substitute color can be one of the first four colors or the substitute color can be another color. One of the advantages of this invention is that one of the first or second cartridges can be a tri-color cartridge which holds three colors. When one of the three colors of the tri-color cartridge is either unavailable or depleted, then a substitute color can be provided that would be a color exactly matching the depleted or unavailable color or one that substantially matches the depleted or unavailable color. This embodiment of the invention is advantageous in that waste of the two remaining colors of a tri-color cartridge is substantially reduced. This brings down the cost per page of a print job by reducing the amount of consumables that are wasted.

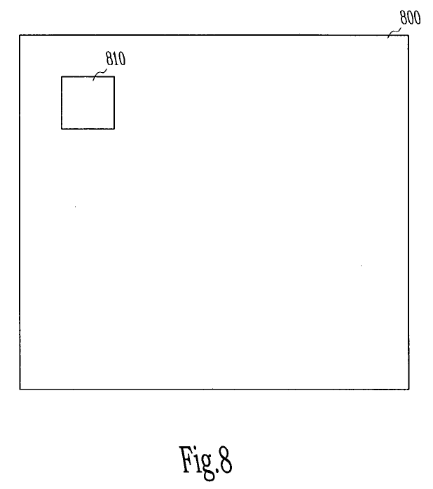

FIG. 7 is a flow chart illustrating another method 700, according to an embodiment of this invention. In this embodiment, a custom color is detected within a cartridge, as depicted by reference numeral 710. A determination that a color to be reproduced matches the custom color within the cartridge is made, as depicted by reference numeral 712. This step can be accomplished by the controller 530, 130, 230, or can be determined by a host computer 570. The custom color is then removed from the cartridge and then placed onto a print medium, as depicted by reference numeral 714. This embodiment or method associated with the invention has several advantages. Among the advantages are that a print job requiring a custom color can be carefully controlled. Some print jobs require very precise control of a color within the print job. For example, company logos or company logos associated with letterhead are just a couple of examples of these types of jobs. If a custom color can be provided within a reservoir and then the controller or host computer can determine when the custom color is needed, the control associated with that color is very tight. The exact ink, as well as the color that results, can be within very tight parameters as set forth by a particular print job.

Of course, other examples of advantages are that a custom color can be one that is used more than other colors in a print job. This reduces waste or reduces the consumables and makes a print job more economical in terms of cost per page.

FIG. 8 is a schematic diagram illustrating a computer-readable medium 800, an associated instruction set 810, according to an embodiment of this invention. The computer-readable medium 800 can be any number of computer-readable medium including a floppy drive, a hard disk drive, a network interface, an interface to the internet, or the like. The computer-readable medium can also be a hard-wired link for a network or be an infrared or radio frequency carrier. The instruction set 810 can be any set of instructions that are executable by an information handling system associated with the printing apparatus discussed. For example, the instruction set can include the method 600 and 700 discussed with respect to FIGS. 6 and 7 above. Other instruction sets can also be placed on the computer-readable medium 800.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of Embodiments of the Invention, with each claim standing on its own as a separate preferred embodiment.

What is claimed is:

1. A printing apparatus comprising:
a first cartridge having at least one reservoir for holding a first color of ink;
a second multi-color cartridge including at least three reservoirs capable of holding a second color of ink, a third color of ink and a fourth color of ink;
a third cartridge having at least one reservoir for holding ink; and
a holder for holding the first cartridge, the second multi-color cartridge, and the third cartridge.

2. The printing apparatus of claim 1, wherein the third cartridge holds a fifth color of ink that is different from the first color, second color, third color, and fourth color of ink.

3. The printing apparatus of claim 1, wherein the third cartridge holds the first color of ink.

4. The printing apparatus of claim 1, wherein the third cartridge holds at least one of the second color, the third color, or the fourth color of ink.

5. The printing apparatus of claim 1, wherein the holder comprises a carriage that includes:
a first cartridge holder;
a second cartridge holder; and
a third cartridge holder.

6. The printing apparatus of claim 5, further comprising:
a chassis;
a guide rod attached to the chassis, wherein the carriage is driven over the guide rod.

7. The printing apparatus of claim 1, further comprising a controller for controlling output of ink from the first cartridge, second cartridge and third cartridge.

8. The printing apparatus of claim 1, further comprising a controller for controlling output of ink from the first cartridge, second cartridge and third cartridge, wherein the controller includes means for determining the color of ink in the third cartridge.

9. The printing apparatus of claim 1, further comprising: a controller for controlling output of ink from the first cartridge, second cartridge and third cartridge; and wherein the controller includes means for automatically substituting ink from the third cartridge for ink of a particular color from the second cartridge when the ink of the particular color from the second cartridge becomes unavailable.

10. The printing apparatus of claim 2, further comprising a controller for controlling the output of ink from the first cartridge, second cartridge and third cartridge, wherein the controller further includes:
means for determining when a color to be printed matches the fifth color; and
means for removing the fifth color from the third cartridge to print the fifth color.

11. The printing apparatus of claim 1, further comprising a fourth cartridge having at least one reservoir for holding ink

12. The printing apparatus of claim 1, wherein the third cartridge is a tri-color cartridge including three reservoirs each capable of holding a different color of ink.

13. In a printer, a method for printing colors comprising:
simultaneously holding a first, second and third cartridge;
detecting a custom color within the third cartridge;
determining when a color to be reproduced matches the custom color within the cartridge; and
placing the color from the third cartridge onto the medium.

14. The method of claim 13, wherein detecting the custom color within the third cartridge further comprises detecting the custom color within the third cartridge in response to input from a user interface.

15. The method of claim 13, wherein detecting the custom color within the third cartridge further comprises detecting the custom color from indicia located on the third cartridge.

16. The method of claim 13, wherein detecting the custom color within the third cartridge further comprises detecting the custom color by reading data from a memory located on the third cartridge.

17. A computer program product for use with a computer system, the computer program product comprising a computer usable medium having a set of instructions executable by a suitably programmed information handling system embodied in the computer usable medium for causing the computer system to:
detect a presence of a group of replaceable ink cartridges in a printer, where the group includes a black ink cartridge, a tri-color ink cartridge and a third cartridge that contains ink having a color that is different than any of the ink colors contained by the black ink cartridge and the tri-color ink cartridge;
determine when a color to be printed matches the color of ink contained by the third cartridge; and
print the custom color from the cartridge.

18. In a printer, a method for printing colors comprising:
holding a plurality of colors in a first cartridge;
holding a second color in a second cartridge;
while holding the plurality of colors in the first cartridge and while holding the second color in the second cartridge, holding a third color in a back-up cartridge;
printing pages using colors supplied from the first and the second cartridge;
detecting when a pre-selected one of the plurality of colors becomes unavailable; and
in response to detecting that the pre-selected color has become unavailable, automatically substituting, while printing pages, the third color from the back-up cartridge for the pre-selected color.

19. The method of claim 18, wherein the third color in the third cartridge substantially matches the pre-selected color.

20. A computer program product for use with a computer system, the computer program product comprising a computer usable medium having a set of instructions executable by a suitably programmed information handling system embodied in the computer usable medium for causing the computer system to:
detect a first, a second, a third and a fourth color in a first cartridge and a second cartridge;
detect when a pre-selected one of the first, second, third and fourth colors is unavailable; and
automatically substitute a color from a third cartridge for the unavailable pre-selected color.

21. A printing apparatus comprising;
a carriage; and
wherein the carriage comprises a frame having slots for holding cartridges therein, the carriage having a first slot for receiving a first cartridge having at least one reservoir for holding a first color of ink, a second slot for receiving a tri-color cartridge and a third slot for receiving a third cartridge having at least one reservoir for holding ink.

22. The printing apparatus of claim 21 wherein the frame also includes a fourth slot for receiving a fourth cartridge having at least one reservoir for holding ink.

23. The printing apparatus of claim 21 further comprising signal lines associated with the first slot, the second slot and the third slot.

24. The printing apparatus of claim 23 wherein the signal lines associated with the first slot, the second slot and the third slot are within a flex cable.

25. The printing apparatus of claim 21 further comprising at least one cartridge for fitting into one of the first slot, the second slot or the third slot.

26. A printing apparatus comprising:
a first cartridge having at least one reservoir for holding a first color of ink;
a second tri-color cartridge including three reservoirs each capable of holding a different color of ink;
a third reservoir having at least one reservoir for holding ink; and
and a mechanism for controlling output of ink from the first cartridge, the second tri-color cartridge and the third reservoir.

27. A printing apparatus comprising:
a holder constructed to simultaneously hold a group of replaceable ink cartridges, where the group of cartridges include a first ink cartridge, a multi-color ink cartridge and an additional ink cartridge;
a print mechanism constructed to selectively and automatically use, while the group of cartridges are being held by the holder, ink from any of the cartridges in the group in order to generate printed output.

28. The printing apparatus of claim 27, wherein the multi-color ink cartridge includes three reservoirs each for holding a different color of ink; wherein the holder includes a first slot to receive the first ink cartridge, a second slot to receive the multi-color ink cartridge and a third slot to receive the additional cartridge; and wherein the mechanism is constructed to use ink from a cartridge located in the third slot as a back-up supply of ink for a pre-selected one of the three reservoirs.

29. The printing apparatus of claim 28, wherein the holder comprises a moveable carriage.

30. The printing apparatus of claim 29, further comprising:
a chassis;
a guide rod attached to the chassis, wherein the carriage is driven over the guide rod.
